(19) United States
(12) Patent Application Publication
(10) Pub. No.: US 2010/0114712 A1
(43) Pub. Date: May 6, 2010

(54) System and Method for Web-Based Advertising Using a Cost-Per-Time Scheme

(76) Inventors: Ryuji Masuda, Santa Rosa Valley, CA (US); Omar Noorzai, Santa Rosa Valley, CA (US); Mustafa Noorzai, Santa Rosa Valley, CA (US)

Correspondence Address: WHITE & CASE LLP;PATENT DEPARTMENT, 1155 AVENUE OF THE AMERICAS, NEW YORK, NY, 10036, US

(21) Appl. No.: 12/263,317

(22) Filed: Oct. 31, 2008

(51) Int. Cl. G06Q 30/00

(52) U.S. Cl. 705/14.69

(57) ABSTRACT

A method for web-based advertising using a cost-per-time scheme includes providing a web page to a browser, the web page containing functionality to enable data to be uploaded to a web server, sending an advertisement to the browser for display on the web page, wherein the browser displays the advertisement at least while an upload of data is in progress, determining a time of an upload of data to the web server, and storing the time of the upload of data wherein the stored time is associated with the advertisement, such that an advertiser is able to be charged for the display of the advertisement based on the time of the upload of data. The advertiser can then be charged for the display of the advertisement on a cost-per-time basis, i.e., charged an amount determined by a cost-per-time rate and how long the advertisement was displayed to the user during the upload.

### FIELD OF THE INVENTION

This invention relates to web-based advertising and more particularly to a system and method for web-based advertising where revenues are calculated on a cost-per-time basis.

### BACKGROUND

Currently, advertisement revenue for advertisements placed on websites is based on three different platforms: Cost per Impression (CPM), Cost per Click (CPC), or Cost per Action (CPA).

CPM is a platform in which an advertiser pays according to how many times an advertisement is viewed by a user. CPM is typically calculated as a cost per thousand impressions, i.e., an amount paid for showing an advertisement one thousand times. For example, if an advertising campaign pays $1.00 CPM, a publisher would earn one tenth of one cent each time a user views an advertisement on the publisher's website. In practice, the publisher may not earn the full amount for each impression if an ad agency provides the advertisements and takes a percentage of the advertising revenues. A publisher may only be paid for unique impressions, where it will only be paid the first time each unique user sees a particular advertisement.

CPC is a platform in which an advertiser pays according to how many times users click on an advertisement. An advertiser will pay a certain amount, typically from five to fifty cents, each time a user clicks on an advertisement displayed on a publisher's website. A publisher may only be paid for the first unique click by a particular user and an ad agency providing the advertisements may take a percentage of the advertising revenues. A drawback of the CPC platform is that a publisher receives no advertising revenue if no users click on an advertisement. Since the performance of CPC advertisements will vary widely among particular advertisements and particular websites, the performance of CPC advertisements is often discussed in terms of effective CPM. For example, if one thousand impressions of an advertisement that pays 25 cents per click are run on a website and four users click on the advertisement, the publisher will have an effective CPM of $1.00.

CPA is a platform in which an advertiser pays each time a user completes a particular action with regard to an advertisement other than clicking on it. Some exemplary user actions are completing a survey, signing up for a subscription, registering with the advertiser, and buying a product. The two basic types of CPA schemes are cost-per-lead and cost-per-sale. In a cost-per-lead scheme, the user action does not require a payment. The user action will typically require the user to register with the advertiser or otherwise provide contact information. A cost-per-lead scheme typically pays between 50 cents and $3.00 per user action. In a cost-per-sale scheme, an advertiser pays each time a user buys one or more products. The amount paid by the advertiser is typically a percentage of the amount of the sale.

The type of advertisements publishers choose to run depends on their audience. In general, publishers run as many CPM advertisements as possible and then use some CPC and/or CPA advertisements to fill any remaining advertisement inventory.

A currently popular platform for placing advertisements and collecting revenues is Google's AdSense platform. With AdSense, each time a webpage is accessed, a Java script pulls advertisements from the AdSense program. The advertisements are targeted, which means that the advertisements are related to the content of the webpage containing the advertisement. If a user clicks on an advertisement, the publisher of the webpage earns a portion of the money that the advertiser will pay Google for the click. Using a platform such as AdSense allows a website publisher to receive advertising revenue without the need to locate and directly interact with advertisers.

Although the CPM, CPC, and CPA platforms are used by many website publishers to generate revenue, each of these platforms has its drawbacks. With the CPM platform, an advertiser pays per “impression,” but there is no assurance that a user actually reads the advertisement. Advertisements on web pages are so common and numerous that many users simply ignore them, so that advertisers may not actually be getting the “impression” that they are paying for. Also, if the advertisement appears on a web page that is only displayed for a moment before the user clicks on a link and moves to another page, there is simply no time for the user to have read the advertisement. As users become more accustomed to web page advertisements and publishers place numerous advertisements on their pages, the likelihood that a user will interact with an advertisement diminishes, making use of the CPC and CPA platforms less attractive to advertisers.

### SUMMARY

A method for web-based advertising using a cost-per-time scheme includes providing a web page to a browser, the web page containing functionality to enable data to be uploaded to a web server, sending an advertisement to the browser for display on the web page, wherein the browser displays the advertisement at least while an upload of data is in progress, determining a time of an upload of data to the web server, and storing the time of the upload of data wherein the stored time is associated with the advertisement, such that an advertiser is able to be charged for the display of the advertisement based on the time of the upload of data. The advertiser can then be charged for the display of the advertisement on a cost-per-time basis, i.e., charged an amount determined by a cost-per-time rate and how long the advertisement was displayed to the user during the upload.

A system for web-based advertising using a cost-per-time scheme includes a web application configured to provide a web page to a browser, wherein the web page is configured to enable a user to upload data to the web application and to display an advertisement while an upload is in progress, a timing unit configured to determine a duration of an upload of data to the web application, and an ad-time database configured to store the duration of the upload of data, wherein the stored duration of the upload is associated with an identifier of the advertisement such that an advertiser is able to be charged for the display of the advertisement based on the duration of the upload of data. The advertiser is charged an amount determined by multiplying a cost-per-time rate by the duration of the upload of data.

### BRIEF DESCRIPTION OF THE DRAWINGS

FIG. 1 is a block diagram of one embodiment of a computer network including a system for web-based advertising using a cost-per-time scheme, according to the invention;

FIG. 2 is a flowchart of method steps for implementing a cost-per-time web advertising scheme, according to one embodiment of the invention; and

FIG. 3 is a flowchart of method steps for implementing a cost-per-time web advertising scheme, according to another embodiment of the invention.

### DETAILED DESCRIPTION

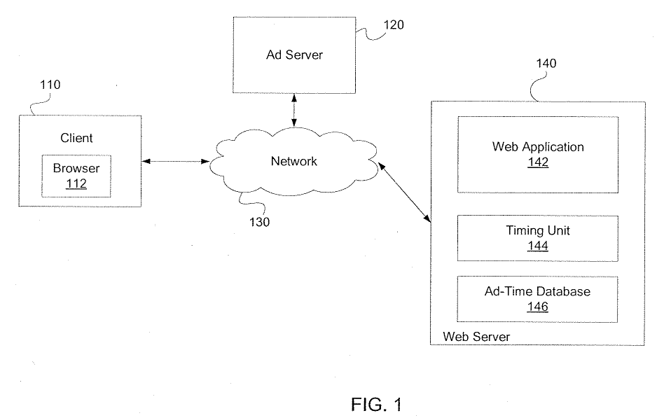

FIG. 1 is a block diagram of one embodiment of a computer network containing a system for web advertising using a cost-per-time scheme, according to the invention. A client 110 includes a web browser 112, which is capable of communicating with a web server 140 via a network 130. Network 130 may be any type of communication network such as a local area network or a wide area network like the Internet, and may be wired, wireless, or a combination. Client 110 may be any type of general computing device such as a desktop or laptop computer, or may be a portable handheld device such as a PDA or a smartphone. Web server 140 includes a web application 142 that is configured to receive uploaded data from browser 112. For example, web application 142 may be a file-sharing site like a photo-sharing site or a video-sharing site. Alternatively, web application 142 may be a website that is a gateway to a content addressable storage (CAS) system, which enables users to upload documents and other data to the CAS system for storage. Web server 140 also includes a timing unit 144 and an ad-time database 146.

Ad server 120 is operated by an entity that provides advertisements to web pages on behalf of advertisers. Ad server 120 sends advertisements to browser 112 in response to requests from applets, such as Java scripts, embedded in web pages displayed by browser 112. The advertisement provider can provide advertisements according to the CPM, CPC, and/or CPA platforms. The advertisement provider also provides advertisements to web pages published by web application 142 on a cost-per-time (CPT) platform. In the CPT platform, advertisers agree to pay for advertisements displayed on web pages during an upload of data from a browser to a website. The advertiser is charged on a cost-per-time basis, i.e., the advertiser is charged based on how long an advertisement is displayed on a web page during an upload. For example, an advertiser may be charged an amount determined by multiplying the duration of an upload by a cost-per-time rate. The cost-per-time rate can be expressed as a cost per second, a cost per millisecond, a cost per microsecond, or a cost per any other appropriate unit of time. To upload data successfully, the user cannot close the web page of web application 142 or browser 112. So with the CPT platform, an advertiser can be reasonably sure that its advertisement will be displayed to the user for a certain amount of time, the entire duration of the upload. While upload times will vary based on the amount of data being uploaded and any congestion on network 130, with the CPT platform an advertiser can be reasonably sure its advertisement will be displayed on a web page for some amount of time during which the user is disinclined to close the web page.

When browser 112 receives a web page from web application 142, applets embedded in the web page request advertisements from ad server 120. These advertisements are provided according to a CPM, CPC, or CPA platform. When a user instructs browser 112 to upload data, such as a photo or a document, to web application 142, browser 112 sends a request to upload data to web application 142. Web application 142 then enables the upload and sends an instruction to ad server 120 to send an advertisement that is associated with a CPT scheme to browser 112. In another embodiment, web application 142 directly embeds an advertisement associated with the CPT scheme into the web page that enables a user to initiate an upload, and that web page and its embedded advertisement are displayed to the user by browser 112 for the duration of the upload.

Timing unit 144 determines the duration of the upload. In one embodiment, timing unit 144 records the start and stop times of the upload and determines a total upload time. In another embodiment, timing unit 144 includes a timer that starts when the upload begins and stops when the upload is complete. The duration of the upload is expressed as a number of time units, for example milliseconds or microseconds. Ad-time database 146 stores the time of the upload and associates the time with an identifier of the particular advertisement that was displayed to the user during the upload. Ad-time database 146 stores all upload times that correspond to an advertisement displayed to a user during an upload and can generate a cumulative time for each advertisement.

Web application 142 sends the cumulative time for each advertisement to ad server 120 and the advertisement provider that operates ad server 120 can issue an invoice or otherwise request payment from the advertisers. The payment amount is determined by multiplying the cumulative time by a cost-per-time rate. In another embodiment, the publisher who operates web application 142 deals directly with the advertisers to request payment for the advertisements.

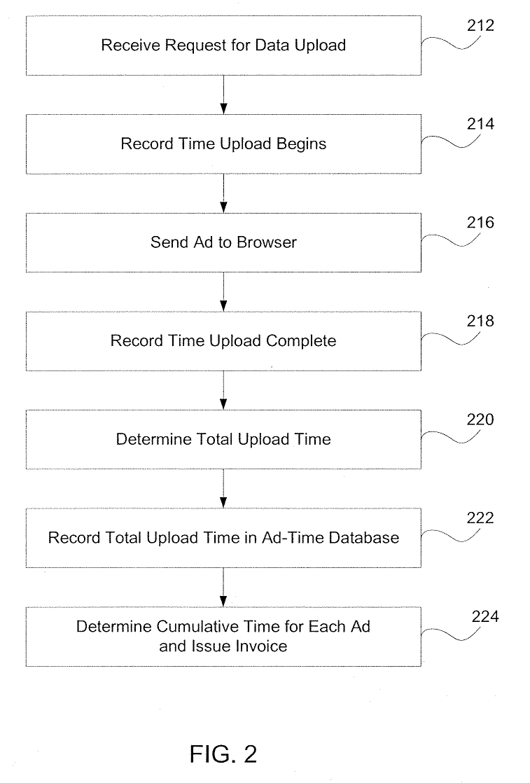

FIG. 2 is a flowchart of method steps for implementing a cost-per-time web advertising scheme, according to one embodiment of the invention. In step 212, web application 142 receives a request from a browser to upload data. In step 214, timing unit 144 records the time that the data begins uploading to web application 142. In step 216, ad server 120 sends an advertisement associated with a CPT scheme to browser 112, which displays the advertisement to the user during the entire upload time. In another embodiment, the advertisement is embedded into the web page provided by web application 142 that enables the user to upload data. In step 218, timing unit 144 records the time when the upload is complete. In step 220, timing unit 144 determines the total upload time. In step 222, the total upload time is recorded in ad-time database 146 such that the total upload time is associated with an identifier of the advertisement that was displayed to the user. In one embodiment, ad-time database 146 adds the total upload time to a cumulative time associated with the advertisement. In step 224, web application 142 determines a cumulative time associated with an advertisement and sends the cumulative time to ad server 120. The operator of ad server 120 then calculates an amount due based on the cumulative time and a cost-per-time rate, and issues an invoice to the advertiser. In another embodiment, web application 142 determines the cumulative time, determines the amount due, and issues an invoice directly to the advertiser.

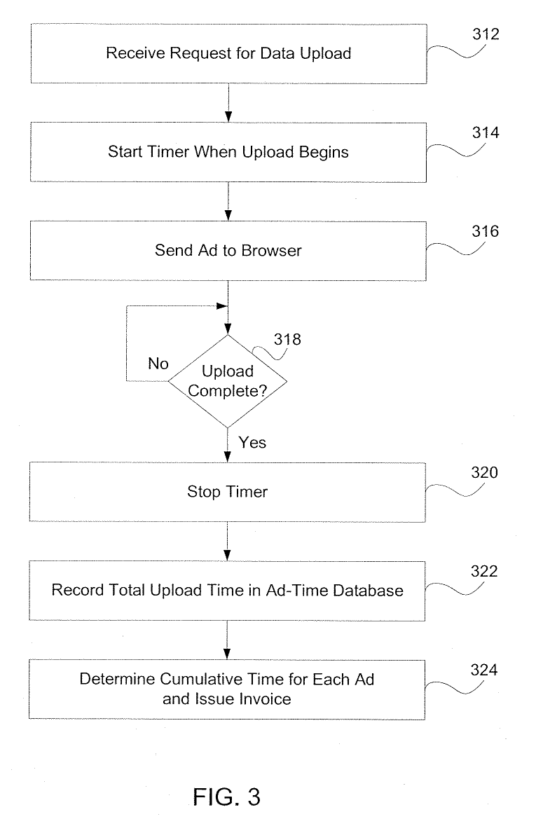

FIG. 3 is a flowchart of method steps for implementing a cost-per-time web advertising scheme, according to another embodiment of the invention. In step 312, web application 142 receives a request from a browser to upload data. In step 314, timing unit 144 starts a timer when the data begins uploading to web application 142. In step 316, ad server 120 sends an advertisement associated with a CPT scheme to browser 112, which displays the advertisement to the user during the entire upload time. In another embodiment, the advertisement is embedded into the web page provided by web application 142 that enables the user to upload data. In step 318, web application 142 determines if the upload is complete. If the upload is complete, in step 320 timing unit 144 stops the timer. In step 322, the total upload time (the value of the timer) is recorded in ad-time database 146 such that the total upload time is associated with an identifier of the advertisement that was displayed to the user. In one embodiment, ad-time database 146 adds the total upload time to a cumulative time associated with the advertisement. In step 324, web application 142 determines a cumulative time associated with an advertisement and sends the cumulative time to ad server 120. The operator of ad server 120 then calculates an amount due based on the cumulative time and a cost-per-time rate, and issues an invoice to the advertiser. In another embodiment, web application 142 determines the cumulative time, determines the amount due, and issues an invoice directly to the advertiser.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method comprising:
providing a web page to a browser, the web page containing functionality to enable data to be uploaded to a web server;
sending an advertisement to the browser for display on the web page;
determining a duration of an upload of data to the web server, wherein the browser displays the advertisement for the duration of the upload of data;
associating the duration of the upload of data with the advertisement; and
requesting payment from an advertiser based on the duration of the upload of data.

2. The method of claim 1, wherein an amount of a payment requested from the advertiser is determined by multiplying the duration of the upload of data by a cost-per-time rate.

3. The method of claim 1, wherein determining a duration of an upload of data to the web server includes timing the upload using a timer at the web server.

4. The method of claim 1, wherein the advertisement is sent to the browser by an advertisement server.

5. The method of claim 1, wherein the advertisement is sent to the browser by the web server.

6. The method of claim 1, wherein the advertisement is sent to the browser concurrently with the web page.

7. A system comprising:
a web application configured to provide a web page to a browser, wherein the web page is configured to enable a user to upload data to the web application and to display an advertisement while an upload is in progress;
a timing unit configured to determine a duration of an upload of data to the web application; and
an ad-time database configured to store the duration of the upload of data, wherein the stored duration of the upload is associated with an identifier of the advertisement such that an advertiser is able to be charged for the display of the advertisement based on the duration of the upload of data.

8. The system of claim 7, wherein the timing unit is configured to record a start time of the upload and an end time of the upload to determine the duration of the upload.

9. The system of claim 7, wherein the timing unit includes a timer configured to time the duration of the upload.

10. The system of claim 7, wherein the web application embeds the advertisement in the web page.

11. A method comprising:
providing a web page to a browser, the web page containing functionality to enable data to be uploaded to a web server;
sending an advertisement to the browser for display on the web page, wherein the browser displays the advertisement at least while an upload of data is in progress;
determining a time of an upload of data to the web server; and
storing the time of the upload of data, wherein the stored time is associated with the advertisement, such that an advertiser is able to be charged for the display of the advertisement based on the time of the upload of data.

12. The method of claim 11, further comprising requesting payment from an advertiser based on the time of the upload of data.

13. The method of claim 12, wherein an amount of a payment requested from the advertiser is determined by multiplying the time of the upload of data by a cost-per-time rate.

14. The method of claim 11, wherein determining a time of an upload of data to the web server includes timing the upload using a timer at the web server.

15. The method of claim 11, wherein the advertisement is sent to the browser by an advertisement server.

16. The method of claim 11, wherein the advertisement is sent to the browser by the web server.

17. The method of claim 11, wherein the advertisement is sent to the browser concurrently with the web page.
